(19) United States
(12) Patent Application Publication
(10) Pub. No.: US 2014/0121987 A1
(43) Pub. Date: May 1, 2014

(54) SYSTEM AND METHOD FOR ALIGNING GENOME SEQUENCE CONSIDERING ENTIRE READ

(71) Applicant: SAMSUNG SDS CO., LTD., Seoul (KR)

(72) Inventor: Minseo PARK, Seoul (KR)

(73) Assignee: SAMSUNG SDS CO., LTD., Seoul (KR)

(21) Appl. No.: 13/972,314

(22) Filed: Aug. 21, 2013

(30) Foreign Application Priority Data
Oct. 29, 2012 (KR) 10-2012-0120634

(51) Int. Cl. G06F 19/22

(52) U.S. Cl. CPC G06F 19/22
USPC 702/19

(57) ABSTRACT

A system and a method for aligning a genome sequence considering an entire read are provided. The system for aligning a genome sequence includes a fragment sequence production unit configured to produce one or more fragment sequences from an entire section of a read sequence, and an alignment unit configured to perform global alignment on the read sequence using the produced fragment sequences.

### CROSS-REFERENCE TO RELATED APPLICATION

This application claims priority to and the benefit of Republic of Korea Patent Application No. 10-2012-0120634, filed on Oct. 29, 2012, the disclosure of which is incorporated herein by reference in its entirety.

### BACKGROUND

1. Field

The present disclosure relates to technology for analyzing a genome sequence.

2. Discussion of Related Art

A next-generation sequencing (NGS) method of producing a large amount of short sequences is rapidly replacing the conventional Sanger's sequencing method due to its inexpensive cost and rapid data generation. Also, various programs for recombining an NGS sequence have developed with a focus on accuracy. However, a cost required to construct a fragment sequence has been reduced to less than half the cost required in the past with current developments in next-generation sequencing technology. As a result, as a quantity of the data is increasingly used, technology for rapidly and accurately processing a large amount of short sequences is required.

The first operation of recombining a sequence is to map a read at an exact position of a reference sequence using an algorithm for aligning a genome sequence. In this case, it is problematic that there are differences in genomes sequence due to the presence of various genetic variations even among subjects of the same species. Also, differences in genome sequences may be caused due to errors in a sequencing process. Therefore, the algorithm for recombining a genome sequence has to effectively enhance mapping accuracy in consideration of the differences in genome sequences and the genetic variations.

In conclusion, as much data on the entire genomic information as possible is required so as to analyze the genomic information. For this purpose, development of an algorithm for resequencing a genome sequence, which has excellent accuracy and high throughput, should also be achieved in advance. However, the conventional methods have limits in satisfying these requirements.

### SUMMARY

The present disclosure is directed to a means for aligning a genome sequence capable of ensuring mapping accuracy and simultaneously improving complexity upon mapping to increase a processing rate.

According to an aspect of the present disclosure, there is provided a system for aligning a genome sequence, which includes a fragment sequence production unit configured to produce one or more fragment sequences from an entire section of a read sequence, and an alignment unit configured to perform global alignment on the read sequence using the produced fragment sequences.

According to another aspect of the present disclosure, there is provided a method of aligning a read sequence in a reference sequence, which includes producing one or more fragment sequences from an entire section of the read sequence at a fragment sequence production unit, and performing global alignment on the read sequence using the produced fragment sequences at an alignment unit.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a diagram explaining a method of aligning a genome sequence according to one exemplary embodiment of the present disclosure;

FIG. 2 is a diagram exemplifying a process of estimating an error bound of a read sequence in the method of aligning a genome sequence according to one exemplary embodiment of the present disclosure;

FIG. 3 is a diagram exemplifying a process of producing a fragment sequence according to one exemplary embodiment of the present disclosure;

FIG. 4 is a diagram exemplifying a process of producing a fragment sequence according to another exemplary embodiment of the present disclosure;

FIG. 5 is a diagram exemplifying a process of producing a fragment sequence according to still another exemplary embodiment of the present disclosure; and

FIG. 6 is a block diagram showing a system for aligning a genome sequence according to one exemplary embodiment of the present disclosure.

### DETAILED DESCRIPTION OF EXEMPLARY EMBODIMENTS

Exemplary embodiments of the present disclosure will be described in detail below with reference to the accompanying drawings. While the present disclosure is shown and described in connection with exemplary embodiments thereof, it will be apparent to those skilled in the art that various modifications can be made without departing from the scope of the present disclosure.

Prior to describing the exemplary embodiments of the present disclosure in detail, first, the terminology used herein will be described in advance, as follows.

First, the term “read sequence” (or abbreviated as “read”) refers to genome sequence data having a short length, which is output from a genome sequencer. Read sequences generally vary in length ranging from approximately 35 to 500 by (base pairs) according to the kind of a genome sequencer. In general, DNA bases are represented by four characters: A, C, G, and T.

The term “reference sequence” refers to a genome sequence used for reference to produce a full-length genome sequence from the read sequences. In analysis of the genome sequence, a large amount of reads output from a genome sequencer are mapped with reference to the reference sequence to complete the full-length genome sequence. According to the present disclosure, the reference sequence may be a sequence (for example, a full-length human genome sequence, etc.) set in advance upon analysis of a genome sequence, or a genome sequence synthesized in a genome sequencer may be used as the reference sequence.

The term “base” refers to a basic unit constituting a reference sequence and a read. As described above, the DNA bases may include four letters: A, C, G, and T, each of which is referred to as a base. That is, the DNA bases are represented by four bases. This is applicable to the read in like manner.

The term “seed” refers to a sequence which is a basic unit used when a read sequence is compared with a reference sequence so as to map the read sequence. In theory, mapping positions of reads should be calculated while sequentially comparing the entire read with the reference sequence beginning from the 1^{st} base of the reference sequence so as to map the read to the reference sequence. However, such a method has a problem in that large amounts of time and computing power are required to map one read. Therefore, a fragment that is a piece that is actually composed of a portion of the read is first mapped to the reference sequence to search for a mapping candidate position of the entire read sequence and map the entire read sequence at a corresponding candidate position (global alignment).

The term “fragment sequence” (or abbreviated as “fragment”) refers to a piece of the read which is used as a candidate to constitute the seed. That is, according to the exemplary embodiments of the present disclosure, one or more fragment sequences are extracted from a read, and only the fragment sequences mapped to the reference sequence among the extracted fragment sequences are collected to constitute a seed group. In this case, the fragment sequences included in the seed group refers to seeds.

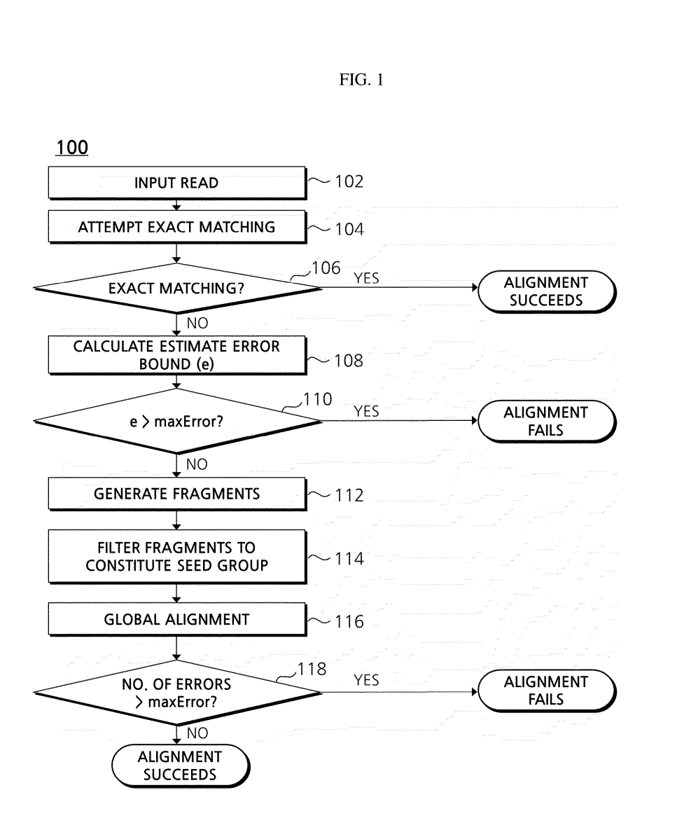

FIG. 1 is a diagram explaining a method 100 of aligning a genome sequence according to one exemplary embodiment of the present disclosure. According to one exemplary embodiment of the present disclosure, the method 100 of aligning a genome sequence refers to a series of processes including comparing read sequences output from a genome sequencer with a target genome sequence and determining a mapping (or aligning) position of the read sequence on the reference sequence so as to construct the entire sequence.

First, when read sequences are outputted from a genome sequencer (Operation 102), exact matching of the entire read sequence with the reference sequence is attempted (Operation 104). From the results obtained in Operation 102, when the exact matching of the entire read succeeds, the alignment is judged to have succeeded without performing an alignment operation (Operation 106). From the results of experiments on human genome sequences, when 1,000,000 read sequences output from a genome sequencer are exactly mapped to the human genome sequences, 231,564 cycles of the exact matching appear to take place in a total of 2,000,000 alignments (1,000,000 alignments for a forward sequence, and 1,000,000 alignments for a reversely complementary sequence). Therefore, the results obtained in Operation 104 show that a work load required for the alignments may be reduced by approximately 11.6%.

On the other hand, when the corresponding read is judged not to be exactly matched in Operation 106, an error bound which may occur when the corresponding read is aligned in reference sequence is estimated (Operation 108).

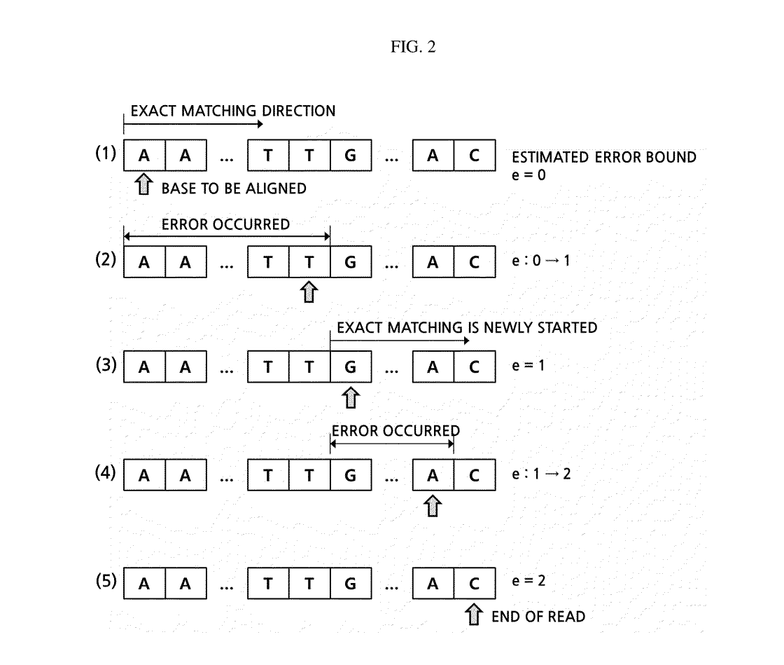

FIG. 2 is a diagram exemplifying a process of estimating an error bound in Operation 108. As shown in FIG. 2(1), an initial estimated error bound value (e) is first set to 0, and exact matching is attempted while advancing from a 1^{st} base of a read sequence one by one in a direction toward the end of the read. In this case, it is assumed that further exact matching from a certain base (a base represented by the second T in the drawing) of the read sequence is impossible to perform, as shown in FIG. 2(2). In this case, this means that an error takes place somewhere in a section spanning from a matching start position to a current position of the read sequence. Therefore, the estimated error bound is increased by one accordingly (e=0→1), and new exact matching starts at the next position (indicated by (3) in the drawing). Next, when the exact matching is judged to be impossible to perform at a certain position again, another error takes place somewhere in another section spanning from a position at which the exact matching re-starts to a current position. As a result, the estimated error bound is increased again by one (e=1→2), and new exact matching starts at the next position (indicated by (4) in the drawing). The estimated error bound when the end of the read is reached through such a process becomes the number of errors that may occur in such a read. (indicated by (5) in the drawing)

When the estimated error bound of the read sequence is calculated through such a process, it is judged whether the calculated estimated error bound exceeds a predetermined maximum error allowable value (maxError) (Operation 110). When the estimated error bound exceeds the maximum error allowable value, alignment of the corresponding read sequence is judged to have failed, and the alignment is then terminated. In the above-described experiments on the human genome sequences, when the estimated error bounds of the remaining reads are calculated on the assumption that the maximum error allowable value (maxError) is set to 3, it is shown that the estimated error bounds of the reads corresponding to a total of 844,891 cycles exceed the maximum error allowable value. That is, the results obtained in Operation 108 show that a work load required for the alignments may be reduced by approximately 42.2%.

On the other hand, when the results of the judgment in Operation 110 show that the estimated error bound is equal to or less than the maximum error allowable value, alignment on the corresponding read sequence is performed, as follows.

First, one or more fragment sequences are produced from the read sequence (Operation 112), and a seed group that is a group of fragment sequences including only the fragment sequences mapped to the reference sequence among the produced one or more fragment sequences is constituted (Operation 114). Then, global alignment on the read sequence is performed using seeds that are the fragment sequences included in the seed group (Operation 116). In this case, when the results of the global alignment shows that the number of errors in the read exceeds a predetermined maximum error allowable value (maxError), the alignment is judged to have failed, and alignment is judged to have succeeded when the number of errors in the read does not exceed the maximum error allowable value (Operation 118).

Hereinafter, specific processes including Operations 112 to 114 will be described in detail.

Producing Fragment Sequences from Read Sequence (Operation 112)

This operation is in earnest to produce fragment sequences which are one or more small pieces from a read sequence so as to perform alignment of the read sequence. In this operation, one or more fragment sequences are produced in consideration of an entire section of the read sequence rather than a portion of the read sequence.

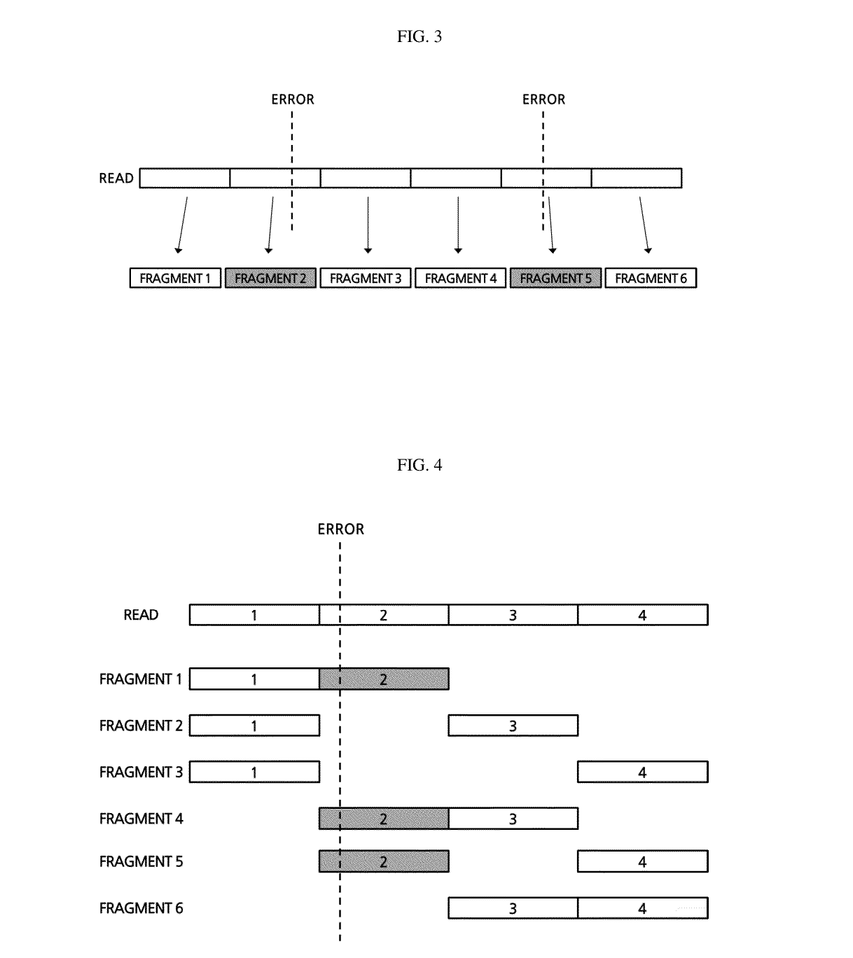

FIGS. 3 to 5 are diagrams explaining one examples of a method of producing a fragment sequence considering an entire section of the read sequence as described above. However, methods of producing a fragment sequence are described for the purpose of illustrations only, but the present disclosure is not limited to a process of producing a certain fragment sequence. That is, it is noted that all algorithms for producing a fragment sequence considering an entire read sequence rather than a portion of the extracted read sequence fall within the scope of the present disclosure.

First, FIG. 3 is a diagram exemplifying a process of producing a fragment sequence according to one exemplary embodiment of the present disclosure. As shown in FIG. 3, according to this exemplary embodiment, fragment sequences may be produced by dividing the entire read sequence into pieces having the predetermined size. That is, each of the pieces divided with a certain length may become a fragment sequence according to the present disclosure. Although the exemplary embodiment in which the read sequence is divided into 6 pieces is shown in FIG. 3, the number of pieces and the lengths of the pieces are not particularly limited, and may be properly adjusted in consideration of the kind of the reference sequence or the length of the read sequence, the maximum error allowable value of the read, etc. Also, although one case in which the read sequence is divided into pieces with no overlapping bases is shown in FIG. 3, the read sequence may also be divided so that some overlapping bases are present in the divided pieces.

FIG. 4 is a diagram exemplifying a process of producing a fragment sequence according to another exemplary embodiment of the present disclosure. As shown in FIG. 4, according to this exemplary embodiment, the fragment sequences may be produced by dividing the entire read sequence into pieces having the predetermined size, followed by combining at least two of the divided pieces of the read sequence. As shown in FIG. 4, for example, the fragment sequences may be produced by dividing the read sequence into 4 pieces (piece 1 to 4) and combining the 4 pieces two by two. Like the above-described exemplary embodiments, the number of the divided pieces, the lengths of the respective pieces and the number of pieces to be combined are not particularly limited, and may be properly adjusted in consideration of the kind of the reference sequence or the length of the read sequence, the maximum error allowable value of the read, etc.

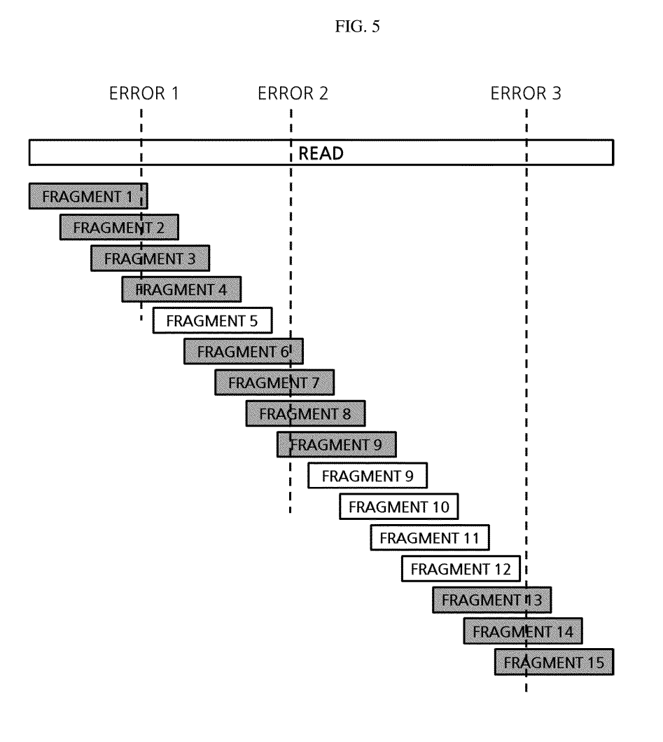

FIG. 5 is a diagram exemplifying a process of producing a fragment sequence according to still another exemplary embodiment of the present disclosure. According to this exemplary embodiment, the fragment sequences are produced by reading a value of the read sequence by a predetermined size while advancing from a 1^{st} base of the read sequence by a predetermined shift distance. The exemplary embodiment shown in FIG. 5 shows a case in which the read sequence has a length of 75 bp (base pairs), the read has a maximum error allowable value of 3 bp, and the fragment sequence has a fragment size of 15 bp, and a migration gap (a shift distance or a shift size) of 4 bp. That is, the fragment sequences are produced while advancing from the 1^{st} base of the read sequence by 4 base pairs. However, the exemplary embodiment shown in FIG. 5 is described for the purpose of illustrations only, and thus the shift distance and the size of the fragment sequence may be, for example, properly adjusted in consideration of the length of the read sequence, the maximum error allowable value of the read, etc. That is, it is noted that the scope of the present disclosure is not particularly limited to the size of the fragment sequence and the shift distance.

Meanwhile, as described above, the lengths of the fragment sequences are not particularly limited in this exemplary embodiment of the present disclosure, but the lengths of the fragment sequences may be preferably determined so that the lengths of the fragment sequences can amount for 20% to 30% of the length of the read sequence. In general, as the lengths of the fragment sequences are shortened, the mapping number of the corresponding fragment sequences to the reference sequence increases. On the other hand, as the lengths of the fragment sequences are lengthened, the mapping number of the corresponding fragment sequences to the reference sequence decreases. In general, considering the length of the read sequence produced in a genome sequencer, the mapping number of the fragment sequences to the reference sequence excessively increases when the fragment sequences are constituted so that the lengths of the fragment sequences can amount for 20% of the length of the read sequence. Therefore, the cycles of global alignments in a subsequent global alignment process may be unnecessarily increased. On the other hand, when the lengths of the fragment sequences amount for 30% of the length of the read sequence, the mapping number of the fragment sequence to the reference sequence may be excessively reduced, thereby degrading mapping accuracy. Accordingly, in the present disclosure, the fragment sequences are constituted in consideration of the length of the read sequence so that the lengths of the fragment sequences can amount for 20% to 30% of the length of the read sequence, thereby ensuring mapping qualities and simultaneously minimizing complexity that may occur upon mapping.

Also, when the reference sequence is a human genome sequence, the fragment sequences may be produced so that the fragment sequences can have a length of 15 by to 30 bp. In general, as the lengths of the fragment sequences are shortened, the mapping number of the corresponding fragment sequences to the reference sequence increases, whereas, as the lengths of the fragment sequences are lengthened, the mapping number of the corresponding fragment sequences to the reference sequence decreases, as described above. In particular, in the case of the human genome sequence, the mapping number of the fragment sequences to the reference sequence drastically increases when the fragment sequences have a length of 14 or less. The following Table 1 lists the average frequencies of occurrence of the fragment sequences in a human genome according to the lengths of the fragment sequences.

TABLE 1

| Length of fragment sequence | Average frequency of occurrence |
|---|---|
| 10 | 2,726.1919 |
| 11 | 681.9731 |
| 12 | 170.9185 |
| 13 | 42.7099 |
| 14 | 10.6470 |
| 15 | 2.6617 |
| 16 | 0.6654 |
| 17 | 0.1664 |

As listed from Table 1, it could be seen that the fragment sequence has a frequency of occurrence of 10 or more when the fragment sequence has a length of 14 by or less, whereas the frequency of occurrence of the fragment sequence decreases to 3 or less when the fragment sequence has a length of 15 bp. That is, when the length of the fragment sequence is set to 15 by or more, the repeats of the fragment sequence are drastically decreased, compared with when the length of the fragment sequence is set to 14 by or less. Also, when the fragment sequence has a length of 30 by or more, the mapping number of the fragment sequence to the reference sequence excessively decreases, thereby degrading mapping accuracy. Accordingly, when the reference sequence is the human genome sequence, the fragment sequences are constituted in the present disclosure so that the fragment sequences can have a length of 15 to 30 bp, thereby ensuring mapping qualities and simultaneously minimizing complexity that may occur upon mapping.

Filtering Produced Fragment Sequences (Operation 114)

When the fragment sequences are produced through such a process, a filtering process of excluding the fragment sequences, which are not mapped to the reference sequence, from the produced fragment sequences is performed to constitute a seed group. That is, exact matching of the produced fragment sequences with the reference sequence is attempted, and thus the fragment sequences (seeds) in which the number of unmatched bases is equal to or less than the predetermined allowable value are constituted into the seed group.

In this case, the allowable value may be properly determined in consideration of the length of the read sequence and the lengths of the fragment sequences. For example, when the read has a short length (approximately 50 by or less), it is desirable to contemplate only the fragment sequences exactly mapped to the reference sequence. In this case, the allowable value may be a null (0). In addition, as the length of the read is lengthened, the allowable value may increase by 1 or 2 to prevent an excessive decrease in mapping accuracy.

One example of such a filtering process will be described, as follows. According to the exemplary embodiment shown in FIG. 3, for example, it is assumed that errors take place at sites corresponding to fragment sequences 2 and 5 in the read as shown in FIG. 3. In this case, when only the fragment sequences exactly mapped to the reference sequence is contemplated as the seeds (that is, when the allowable value is set to 0), the fragment sequences 2 and 5 carrying the errors are not exactly mapped to the reference sequence. As a result, the seed group includes only the four fragment sequences including fragment sequences 1, 3, 4 and 6.

According to the exemplary embodiment shown in FIG. 4, when it is assumed that errors take place at a site corresponding to the 2^{nd} piece as shown in FIG. 4, the fragment sequences 1, 4 and 5 carrying the errors is excluded from the seed group, and only the fragment sequences 2, 3 and 6 are included in a candidate fragment sequence.

According to the exemplary embodiment shown in FIG. 5, when it is assumed that errors take place at three sites in the read (indicated by dotted lines in the drawing), the fragment sequences (shown in grey in the drawing) carrying the errors are not exactly mapped to the reference sequence, but only the fragment sequences 5, 9, 10, 11 and 12 which are not affected by the errors are exactly mapped to the reference sequence. As a result, the seed group includes only the five fragment sequences as described above.

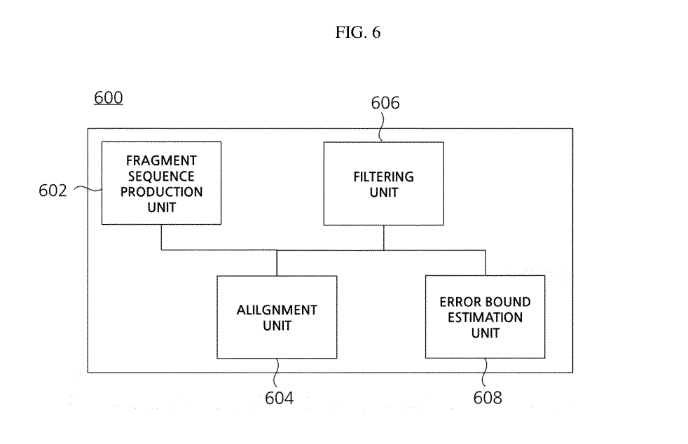

FIG. 6 is a block diagram showing a system 600 for aligning a genome sequence according to one exemplary embodiment of the present disclosure. The system 600 for aligning a genome sequence according to one exemplary embodiment of the present disclosure is a device for performing the above-described method of resequencing a genome sequence, and includes a fragment sequence production unit 602 and an alignment unit 604. As necessary, the system 600 for aligning a genome sequence may further include a filtering unit 606 and an error bound estimation unit 608.

The fragment sequence production unit 602 produces one or more fragment sequences from an entire section of the read sequence obtained in a genome sequencer. In this case, the fragment sequence production unit 602 may produce the fragment sequences by reading a value of the read sequence by a predetermined size while advancing from a 1^{st} base of the read sequence by a predetermined shift distance, may produce the fragment sequences by dividing the read sequence into pieces having the predetermined size, or may produce the fragment sequences by combining at least two of the divided pieces of the read sequence. As described above, however, it is noted that the present disclosure is not limited to the certain methods of producing a fragment sequence as described above, and methods considering the entire read sequence are not used without limitation as the certain methods of producing a fragment sequence.

Also, the fragment sequence production unit 602 may produce the fragment sequences so that the lengths of the fragment sequences can amount for 20% to 30% of the length of the read sequence. In particular, when the human genome sequence is used as the reference sequence, the fragment sequences may be produced so that the fragment sequences can have a length of 15 by to 30 bp.

The alignment unit 604 performs global alignment on the read sequence using the produced fragment sequences.

The filtering unit 606 constitutes a seed group including only the fragment sequences mapped to the reference sequence among the one or more fragment sequences produced at the fragment sequence production unit 602. In the configuration as describe above, the alignment unit 604 may perform global alignment on the read sequence using the fragment sequences included in the seed group produced at the filtering unit 606. In this case, the fragment sequences mapped to the reference sequence refer to fragment sequences in which the number of unmatched bases is equal to or less than a predetermined number from the results of exact matching with the reference sequence.

The error bound estimation unit 608 calculates an estimated error bound when the read sequence is aligned in the reference sequence. More particularly, the error bound estimation unit 608 exactly matches the read sequences with the reference sequence while advancing from a 1^{st} base of the read sequence one by one. Here the error bound estimation unit 608 may newly perform the exact matching while advancing from a base next to a certain position of the read sequence one by one when it is impossible to perform the exact matching at the corresponding position, and set the number of positions at which it is judged not to perform the exact matching as an estimated error bound of the read sequence when the last base of the read sequence is reached. The specific process of estimating an error bound has been described in detail as shown in FIG. 2, and thus detailed description of the specific process is omitted for clarity.

Meanwhile, the fragment sequence production unit 602 may be configured to produce one or more fragment sequences from an entire section of the read sequence even when the estimated error bound is equal to or less than a predetermined maximum error allowable value. It has been previously described that the alignment of the corresponding read sequence is judged to have failed when the estimated error bound exceeds the maximum error allowable value.

Meanwhile, the exemplary embodiments of the present disclosure may include a computer-readable recording medium equipped with programs for executing the methods described herein on a computer. The computer-readable recording medium may include program commands, local data files, local data structures, etc., which may be used alone or in combination. The computer-readable recording medium may be particularly designed or constructed for the purpose of the present disclosure, or may also be known and used by persons of ordinary skill in the computer software-related art. Examples of the computer-readable recording medium may include magnetic media such as hard disks, floppy disks and magnetic tapes, optical recording media such as CDROMs and DVDs, magneto-optical media such as floppy disks, and hardware devices, such as ROMs, RAMs and flash memories, which are particularly constructed to store and execute the program commands. Examples of the program commands may include high-level language codes capable of being executed by a computer using an interpreter, as well as machine codes such as those constructed by compilers.

According to the exemplary embodiments of the present disclosure, the seeds (fragment sequences) can be selected upon alignment of the read sequence in consideration of an entire section of the read sequence rather than a certain portion of the read sequence, thereby improving mapping accuracy over the algorithms in which a portion of the read is considered.

It will be apparent to those skilled in the art that various modifications can be made to the above-described exemplary embodiments of the present disclosure without departing from the spirit or scope of the present disclosure. Thus, it is intended that the present disclosure covers all such modifications provided they come within the scope of the appended claims and their equivalents.

What is claimed is:

1. A system, intended for use in aligning a genome sequence, the system comprising a computer executing program commands and thereby implementing:
a fragment sequence production unit configured to produce one or more fragment sequences from an entire section of a read sequence; and
an alignment unit configured to perform a global alignment operation on the read sequence with respect to a reference sequence, using the produced fragment sequences.

2. The system of claim 1, wherein the fragment sequence production unit is further configured to:
store a predetermined read size value and a predetermined shift distance value; and
produce the fragment sequences by reading the read sequence for the predetermined read size value, while advancing from a first base of the read sequence by the predetermined shift distance value.

3. The system of claim 1, wherein the fragment sequence production unit is further configured to produce the fragment sequences by dividing the read sequence into a plurality of pieces, each having a respective size corresponding to a predetermined read size value, to thereby obtain divided pieces of the read sequence.

4. The system of claim 3, wherein the fragment sequence production unit is further configured to produce the fragment sequences by combining at least two of the divided pieces of the read sequence.

5. The system of claim 1, wherein the fragment sequence production unit is further configured to produce the fragment sequences to have respective lengths from 20% to 30% of a respective length of the read sequence.

6. The system of claim 1, wherein the fragment sequence production unit is further configured to produce the fragment sequences to have respective lengths of 15 by to 30 bp.

7. The system of claim 1, further comprising
a filtering unit configured to constitute a seed group including only ones, of the fragment sequences, that map to the reference sequence, the seed group thereby including mapped fragment sequences;
wherein the alignment unit is further configured to perform the global alignment operation on the read sequence using the mapped fragment sequences.

8. The system of claim 7, wherein the mapped fragment sequences are selected so as to have a respective number of unmatched bases is not more than a predetermined number from the results of exact matching with the reference sequence.

9. The system of claim 1, further comprising:
an error bound estimation unit configured to calculate an estimated error bound when the alignment unit performs the global alignment operation on the read sequence with respect to the reference sequence;
wherein the fragment sequence production unit is further configured to produce the fragment sequences from an entire section of the read sequence when the estimated error bound is not more than a predetermined maximum error allowable value.

10. The system of claim 9, wherein:
the error bound estimation unit is further configured to exactly match the read sequence with the reference sequence while advancing one by one from a first base of the read sequence;
the error bound estimation unit is further configured to newly perform the exact matching while advancing one by one from a base next to a certain position of the read sequence in response to a determination that the exact matching at the corresponding position cannot be successfully performed; and
the error bound estimation unit is further configured to set a number of positions, at which the determination that the exact matching cannot be successfully performed, as an estimated error bound of the read sequence when the last base of the read sequence is reached.

11. A method, intended for use in aligning a read sequence in a reference sequence, the method comprising:
producing, with a fragment sequence production unit, one or more fragment sequences from an entire section of the read sequence; and
performing a global alignment operation, with an alignment unit, on the read sequence, with respect to a reference sequence using the produced fragment sequences.

12. The method of claim 11, wherein the producing of the fragment sequences comprises:
storing a predetermined read size value and a predetermined shift distance value; and
producing the fragment sequences by reading the read sequence for the predetermined read size value, while advancing from a first base of the read sequence by the predetermined shift distance value.

13. The method of claim 11, wherein the producing of the fragment sequences further comprises producing the fragment sequences by dividing the read sequence into a plurality of pieces, each having a respective size corresponding to a predetermined read size value, to thereby obtain divided pieces of the read sequence.

14. The method of claim 13, wherein the producing of the fragment sequences further comprises producing the fragment sequences by combining at least two of the divided pieces of the read sequence.

15. The method of claim 11, wherein the producing of the fragment sequences further comprises producing the fragment sequences to have respective lengths from 20% to 30% of a respective length of the read sequence.

16. The method of claim 11, wherein the producing of the fragment sequences further comprises:
producing the fragment sequences to have respective lengths of 15 by to 30 bp.

17. The method of claim 11, further comprising:
constituting a seed group including only ones, of the fragment sequences, that map to the reference sequence, the seed group thereby including mapped fragment sequences;
wherein the performing of the global alignment comprises is carried out on the read sequence using the mapped fragment sequences .

18. The method of claim 17, wherein the mapped fragment sequences are selected so as to have a respective number of unmatched bases not exceeding a predetermined number from the results of exact matching with the reference sequence.

19. The method of claim 11, further comprising:
using an estimated error bound unit calculate an estimated error bound when the alignment unit performs the global alignment operation on the read sequence with respect to the reference sequence;
wherein the producing of the fragment sequences further comprises producing the fragment sequences from an entire section of the read sequence when the estimated error bound is not more than a predetermined maximum error allowable value.

20. The method of claim 19, wherein the calculating of the estimated error bound further comprises:
exactly matching the read sequences with the reference sequence while advancing one by one from a first base of the read sequence;
wherein the exact matching is newly performed while advancing one by one from a base next to a certain position of the read sequence in response to a determination that the exact matching at the corresponding position cannot be successfully performed; and
setting a number of positions at which the determination that the exact matching cannot be successfully performed, as an estimated error bound of the read sequence when the last base of the read sequence is reached.
